(19) United States
(12) Patent Application Publication
(10) Pub. No.: US 2022/0041457 A1
(43) Pub. Date: Feb. 10, 2022

(54) SYNTHESIS OF SILICON PRODUCTS

(71) Applicant: 6K Inc., North Andover, MA (US)

(72) Inventors: Adrian Pullen, Boston, MA (US); Richard K. Holman, Wellesley, MA (US)

(21) Appl. No.: 17/444,529

(22) Filed: Aug. 5, 2021

Related U.S. Application Data
(60) Provisional application No. 63/062,832, filed on Aug. 7, 2020.

(51) Int. Cl. C01B 33/18

(52) U.S. Cl. CPC C01B 33/182; C01P 2006/40; C01P 2004/32

(57) ABSTRACT

Disclosed herein are embodiments of producing Si or SiOₓ from inexpensive silica sources. In some embodiments, plasma processing can be used to covert the silica sources to the silicon products. Unique morphologies can be formed in some embodiments. In some embodiments, reducing agents, catalysts, and/or salts can be used to provide advantageous properties.

### REFERENCE TO RELATED APPLICATIONS

This application claims the priority benefit under 35 U.S.C. § 119(e) of U.S. Provisional Application No. 63/062,832, filed Aug. 7, 2020, the entire disclosure of which is incorporated herein by reference.

### BACKGROUND

### Field

The present disclosure is generally directed towards the synthesis of valuable silicon products from low-cost silica sources.

### SUMMARY

Disclosed herein are embodiments for methods for producing a spheroidized powder from a silica source, the method comprising: introducing silica source feed material into a microwave plasma torch; and melting and spheroidizing the silica source feed material within a plasma generated by the microwave plasma torch to form a spheroidized powder.

In some embodiments, the method further comprises forming an anode from the spheroidized powder. In some embodiments, the method further comprises forming a battery from the anode. In some embodiments, high energy milling is not used. In some embodiments, lithographic processing is not used.

In some embodiments, the silicon spheroidized powder is Si or SiOₓ. In some embodiments, the silica source feed material is a diatom. In some embodiments, the silica source feed material is a silica colloid. In some embodiments, n the silica source feed material is fumed silica.

In some embodiments, the microwave plasma torch uses a gas selected from the group consisting of hydrogen, oxygen, argon, carbon monoxide and methane. In some embodiments, the gas is under high pressure.

Some embodiments herein are directed to spheroidized powders formed by a process comprising: introducing silica source feed material into a microwave plasma torch; and melting and spheroidizing the silica source feed material within a plasma generated by the microwave plasma torch to form a spheroidized powder.

Some embodiments herein are directed to spheroidized powders formed by a process comprising: introducing silica source feed material into a microwave plasma torch; introducing a reducing gas into the microwave plasma torch; and melting and spheroidizing the silica source feed material within a plasma generated by the microwave plasma torch to form a spheroidized powder.

Some embodiments herein are directed to spheroidized powders formed by a process comprising: introducing silica source feed material into a microwave plasma torch, the silica source contacted with one or more solid reducing agents; introducing a reducing gas into the microwave plasma torch; and melting and spheroidizing the silica source feed material within a plasma generated by the microwave plasma torch to form a spheroidized powder.

Some embodiments herein are directed to methods for reducing silica materials using a plasma, the method comprising introducing silica source feed material into a microwave plasma torch; introducing a reducing gas into the microwave plasma torch; and melting and spheroidizing the silica source feed material within a plasma generated by the microwave plasma torch to form a spheroidized powder.

Some embodiments herein are directed to methods for reducing silica materials using a plasma, the method comprising introducing silica source feed material into a microwave plasma torch, the silica source contacted with one or more solid reducing agents; introducing a reducing gas into the microwave plasma torch; and melting and spheroidizing the silica source feed material within a plasma generated by the microwave plasma torch to form a spheroidized powder.

In some embodiments, the plasma is generated by a microwave source via a torch. In some embodiments, the silica materials compounded with the one or more solid reducing agents. In some embodiments, the one or more solid reducing agents comprise carbon. In some embodiments, the one or more solid reducing agents comprise metal.

In some embodiments, a metal catalyst is added to silica source feed material prior to introducing the silica source feed material into the microwave plasma source. In some embodiments, a salt composition formulated to melt in the plasma is added to the microwave plasma torch.

### BRIEF DESCRIPTION OF THE DRAWINGS

FIG. 1 illustrates the relation between hydrogen content, particle size and degree of reduction as measured by inert gas fusion.

FIG. 2 illustrates an example embodiment of a method of producing powders according to the present disclosure.

FIG. 3 illustrates an embodiment of a microwave plasma torch that can be used in the production of powders, according to embodiments of the present disclosure.

FIGS. 4A-4B illustrate embodiments of a microwave plasma torch that can be used in the production of powders, according to a side feeding hopper embodiment of the present disclosure.

### DETAILED DESCRIPTION

Metallurgical grade silicon can be made by carbothermal reduction at high temperature. In the reduced state it is then refined to a range of purity grades. These processes carry high cost both financially and environmentally.

Silicon anodes for lithium ion batteries are a growing area of focus for the industry as they enable a significant increase in cell capacity over the incumbent graphite materials. However, for silicon to provide both high capacity and long cycle life, complex shapes and small size is required. The shapes and size can enable it to contain the swelling upon lithiation and avoid fracture which results in capacity fade. Forming such material is often expensive relying on lithographic, chemical vapor deposition and other methods that are difficult to scale.

In some embodiments, reducing plasmas, such as microwave plasma, can be used to reduce inexpensive silica sources to a silicon product, either Si or SiOₓ.

Such silica sources can have complex shapes, such as diatoms, or very small size, such as silica colloids (e.g., less than 100 nm). Alternative sources include fumed silica, for example 5-10 nm in size, which can be made from silane or silicon tetrachloride. These shapes may be difficult to manufacture into anode materials using known methods as it requires either lithographic gas phase processes or high energy milling operations, both of which are expensive and time consuming. Advantageously, the disclosure has unexpectedly reduced these issues. Further, unexpected and unusual morphologies can be imparted into the silicon products.

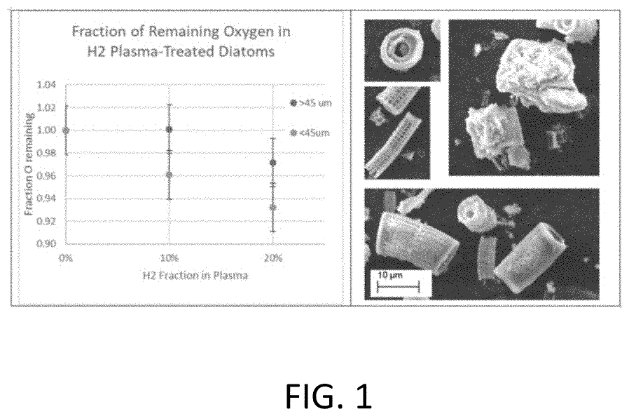

In some embodiments, the reduction of diatoms (e.g., amorphous silica skeletons of planktons) can be performed using hydrogen plasmas, such as microwave plasmas, up to 20% in argon. FIG. 1 shows the relation between hydrogen content, particle size and degree of reduction as measured by inert gas fusion. These results show that the reduction is possible even in rather mild conditions of dilute hydrogen. Further, advantageously these precursor diatoms may have open porosity which may cycle well because they could contain the swelling endemic with silicon anode materials upon lithiation.

As shown in FIG. 1, the oxygen content of the process materials is presented (1=pure silica, 0=silicon) as a function of hydrogen content in the plasma. So as hydrogen content in the plasma increases, more reduction is observed (lower oxygen content). The two curves shown are for different size cuts showing that smaller particles were more reduced than larger ones. This is consistent with the fact that the gas phase reduction takes place only at the surface and so higher surface to mass ratio of smaller particles enables greater reduction.

In some embodiments, different hydrogen concentrations can be used to form different components. For example, up to 10%, 20%, 30%, 40%, 50%, 60%, 70%, 80%, 90%, 95%, or 99% (or about 10%, about 20%, about 30%, about 40%, about 50%, about 60%, about 70%, about 80%, about 90%, about 95%, or about 99%) hydrogen can be used. In some embodiments, the hydrogen can be diluted by one or more of other gases, such as argon, carbon monoxide, and methane. In some embodiments, the gas used can be an aggressive reducing agent. In some embodiments, the gas can be under high pressure. Reducing gasses can be either fed through the torch or injected into the plasma plume below the torch.

In some embodiments, reducing agents can also be added with the silica in, for example, solid form. These can be incorporated into a silica feedstock via, as examples, spray drying or milling/pelletizing. Such feedstocks can provide intimate contact between the silica source and the solid reducing agent such that, when fed to the plasma, solid state reduction can take place. Reducing agents can include carbon in any reduced form such as coke. Similarly, metals such as aluminum, titanium, magnesium or calcium can be used.

In some embodiments, catalysts can optionally be added to the solid-reducing-agent feedstocks. These can be particularly effective when they promote the decomposition of CO₂ to CO as iron is known to do. A variety of transition metals can serve this function including, but not limited, to Fe, Mn, Co, Ni, Mo. These can be provided in either metal or salt form such chlorides or nitrates. Further, one or more types of catalysts can be used.

In some embodiments, solid-reducing-agent feedstocks can be additionally formulated with salt formulations such that, at plasma temperature, the salt is in the molten form. Such salts can be halogens, such as chlorides or fluorides, or oxoanions, such as nitrates or phosphates. In either type, cations can be selected from alkaline and alkaline earth elements such as, for example, sodium, lithium, phosphorous, cesium, rubidium, magnesium, calcium. These salts can be effective at increasing the rate of reduction when metallic reducing agents are used.

When solid-reducing-agent feedstocks are employed they can be used with either reducing plasmas such as H₂, CO or neutral plasmas such as N₂.

In some embodiments, the feedstock can fed into the plasma system, discussed below, as a discrete powder. In some embodiments, the feedstock can be fed as a slurry or spray dried compounded powder.

### Plasma Processing

The above disclosed particles/structures/powders/precursors can be used in a number of different processing procedures. For example, spray/flame pyrolysis, radiofrequency plasma processing, and high temperature spray driers can all be used. The following disclosure is with respect to microwave plasma processing, but the disclosure is not so limiting.

In some cases, the feedstock may include a well-mixed slurry containing the constituent solid materials suspended in a liquid carrier medium which can be fed through a droplet making device. Some embodiments of the droplet making device include a nebulizer and atomizer. The droplet maker can produce solution precursor droplets with diameters ranging approximately 1 um-200 um. The droplets can be fed into the microwave plasma torch, a plasma plume of the microwave plasma torch, and/or an exhaust of the microwave plasma torch. As each droplet is heated within a plasma hot zone created by the microwave plasma torch, the carrier liquid is driven off and the remaining dry components melt to form a molten droplet containing the constituent elements. The plasma gas can be argon, nitrogen, helium hydrogen or a mixture thereof.

In some embodiments, the droplet making device can sit to the side of the microwave plasma torch. The feedstock material can be fed by the droplet making device from the side of the microwave plasma torch. The droplets can be fed from any direction into the microwave generated plasma.

Amorphous material can be produced after the precursor is processed into the desired material and is then cooled at a rate sufficient to prevent atoms to reach a crystalline state. The cooling rate can be achieved by quenching the material within 0.05-2 seconds of processing in a high velocity gas stream. The high velocity gas stream temperature can be in the range of −200° C.-40° C.

Alternatively, crystalline material can be produced when the plasma length and reactor temperature are sufficient to provide particles with the time and temperature necessary for atoms to diffuse to their thermodynamically favored crystallographic positions. The length of the plasma and reactor temperature can be tuned with parameters such as power (2-120 kW), torch diameter (0.5-4″), reactor length (0.5-30′), gas flow rates (1-20 CFM), gas flow characteristics (laminar or turbulent), and torch type (laminar or turbulent). Longer time at the right temperature results in more crystallinity.

The process parameters can be optimized to obtain maximum spheroidization depending on the feedstock initial condition. For each feedstock characteristic, process parameters can be optimized for a particular outcome. U.S. Pat. Pub. No. 2018/0297122, U.S. Pat. Nos. 8,748,785 B2, and 9,932,673 B2 disclose certain processing techniques that can be used in the disclosed process, specifically for microwave plasma processing. Accordingly, U.S. Pat. Pub. No. 2018/0297122, U.S. Pat. Nos. 8,748,785 B2, and 9,932,673 B2 are incorporated by reference in its entirety and the techniques describes should be considered to be applicable to the feedstock described herein.

One aspect of the present disclosure involves a process of spheroidization using a microwave generated plasma. The powder feedstock is entrained in a gas environment and injected into the microwave plasma environment. Upon injection into a hot plasma (or plasma plume or exhaust), the feedstock is spheroidized and released into a chamber filled with a gas and directed into drums where is it stored. This process can be carried out at atmospheric pressure, in a partial vacuum, or at a higher pressure than atmospheric pressure. In alternative embodiments, the process can be carried out in a low, medium, or high vacuum environment. The process can run continuously and the drums are replaced as they fill up with spheroidized particles.

Advantageously, varying cooling processing parameters has been found to alter the characteristic microstructure of the end particles. A higher cooling rate results in a finer structure. Non-equilibrium structure may be achieved via high cooling rates.

Cooling processing parameters include, but are not limited to, cooling gas flow rate, residence time of the spheroidized particles in the hot zone, and the composition or make of the cooling gas. For example, the cooling rate or quenching rate of the particles can be increased by increasing the rate of flow of the cooling gas. The faster the cooling gas is flowed past the spheroidized particles exiting the plasma, the higher the quenching rate-thereby allowing certain desired microstructures to be locked-in. Residence time of the particles within the hot zone of the plasma can also be adjusted to provide control over the resulting microstructure. Residence time can be adjusted by adjusting such operating variables as particle injection rate and flow rate (and conditions, such as laminar flow or turbulent flow) within the hot zone. Equipment changes can also be used to adjust residence time. For example, residence time can be adjusted by changing the cross-sectional area of the hot zone.

Another cooling processing parameter that can be varied or controlled is the composition of the cooling gas. Certain cooling gases are more thermally conductive than others. For example helium is considered to be a highly thermally conductive gas. The higher the thermal conductivity of the cooling gas, the faster the spheroidized particles can be cooled/quenched. By controlling the composition of the cooling gas (e.g., controlling the quantity or ratio of high thermally conductive gasses to lesser thermally conductive gases) the cooling rate can be controlled.

In one exemplary embodiment, inert gas is continually purged to remove oxygen within a powder-feed hopper. A continuous volume of powder feed is then entrained within an inert gas and fed into the microwave generated plasma to prevent excessive oxidation of the material. In one example, the microwave generated plasma may be generated using a microwave plasma torch, as described in U.S. Pat. Nos. 8,748,785, 9,023,259, 9,206,085, 9,242,224, and 10,477,665 each of which is hereby incorporated by reference in its entirety.

In some embodiments, the particles are exposed to a uniform (or non-uniform) temperature profile at between 4,000 and 8,000 K within the microwave generated plasma. In some embodiments, the particles are exposed to a uniform temperature profile at between 3,000 and 8,000 K within the microwave generated plasma. Within the plasma torch, the powder particles are rapidly heated and melted. As the particles within the process are entrained within a gas, such as argon, generally contact between particles is minimal, greatly reducing the occurrence of particle agglomeration. The need for post-process sifting is thus greatly reduced or eliminated, and the resulting particle size distribution could be practically the same as the particle size distribution of the input feed materials. In exemplary embodiments, the particle size distribution of the feed materials is maintained in the end products.

Within the plasma, plasma plume, or exhaust, the melted materials are inherently spheroidized due to liquid surface tension. As the microwave generated plasma exhibits a substantially uniform temperature profile, more than 90% spheroidization of particles could be achieved (e.g., 91%, 93%, 95%, 97%, 99%, 100%). After exiting the plasma, the particles are cooled before entering collection bins. When the collection bins fill, they can be removed and replaced with an empty bin as needed without stopping the process.

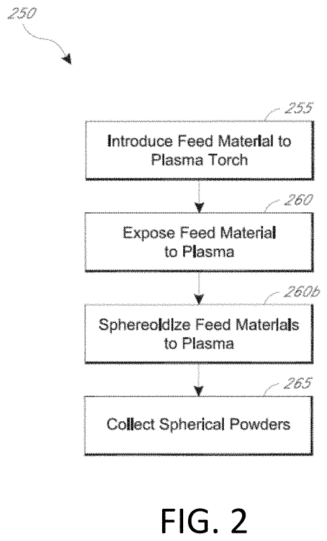

FIG. 2 is a flow chart illustrating an exemplary method (250) for producing spherical powders, according to an embodiment of the present disclosure. In this embodiment, the process (250) begins by introducing a feed material into a plasma torch (255). In some embodiments, the plasma torch is a microwave generated plasma torch or an RF plasma torch. Within the plasma torch, the feed materials are exposed to a plasma causing the materials to melt, as described above (260). The melted materials are spheroidized by surface tension, as discussed above (260b). After exiting the plasma, the products cool and solidify, locking in the spherical shape and are then collected (265).

In some embodiments, the environment and/or sealing requirements of the bins are carefully controlled. That is, to prevent contamination or potential oxidation of the powders, the environment and or seals of the bins are tailored to the application. In one embodiment, the bins are under a vacuum. In one embodiment, the bins are hermetically sealed after being filled with powder generated in accordance with the present technology. In one embodiment, the bins are back filled with an inert gas, such as, for example argon. Because of the continuous nature of the process, once a bin is filled, it can be removed and replaced with an empty bin as needed without stopping the plasma process.

The methods and processes in accordance with the disclosure can be used to make powders, such as spherical powders.

In some embodiments, the processing discussed herein, such as the microwave plasma processing, can be controlled to prevent and/or minimize certain elements from escaping the feedstock during the melt, which can maintain the desired composition/microstructure.

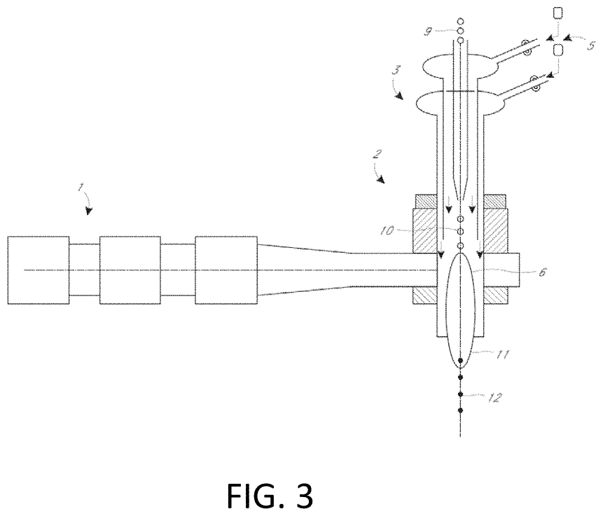

FIG. 3 illustrates an exemplary microwave plasma torch that can be used in the production of powders, according to embodiments of the present disclosure. As discussed above, feed materials 9, 10 can be introduced into a microwave plasma torch 3, which sustains a microwave generated plasma 11. In one example embodiment, an entrainment gas flow and a sheath flow (downward arrows) may be injected through inlets 5 to create flow conditions within the plasma torch prior to ignition of the plasma 11 via microwave radiation source 1.

In some embodiments, the entrainment flow and sheath flow are both axis-symmetric and laminar, while in other embodiments the gas flows are swirling. The feed materials 9 are introduced axially into the microwave plasma torch, where they are entrained by a gas flow that directs the materials toward the plasma. Within the microwave generated plasma, the feed materials are melted in order to spheroidize the materials. Inlets 5 can be used to introduce process gases to entrain and accelerate particles 9, 10 along axis 12 towards plasma 11. First, particles 9 are accelerated by entrainment using a core laminar gas flow (upper set of arrows) created through an annular gap within the plasma torch. A second laminar flow (lower set of arrows) can be created through a second annular gap to provide laminar sheathing for the inside wall of dielectric torch 3 to protect it from melting due to heat radiation from plasma 11. In exemplary embodiments, the laminar flows direct particles 9, 10 toward the plasma 11 along a path as close as possible to axis 12, exposing them to a substantially uniform temperature within the plasma.

In some embodiments, suitable flow conditions are present to keep particles 10 from reaching the inner wall of the plasma torch 3 where plasma attachment could take place. Particles 9, 10 are guided by the gas flows towards microwave plasma 11 where each undergoes homogeneous thermal treatment. Various parameters of the microwave generated plasma, as well as particle parameters, may be adjusted in order to achieve desired results. These parameters may include microwave power, feed material size, feed material insertion rate, gas flow rates, plasma temperature, residence time and cooling rates. In some embodiments, the cooling or quenching rate is not less than 10⁺³ degrees C./sec upon exiting plasma 11. As discussed above, in this particular embodiment, the gas flows are laminar; however, in alternative embodiments, swirl flows or turbulent flows may be used to direct the feed materials toward the plasma.

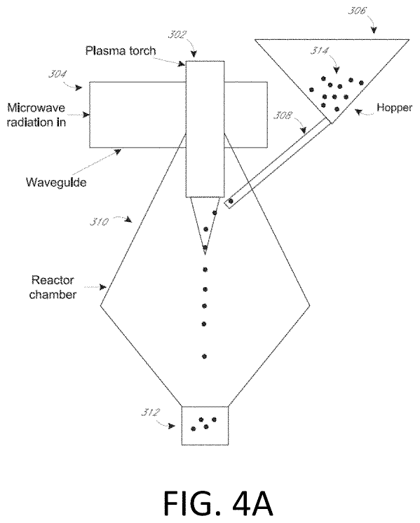

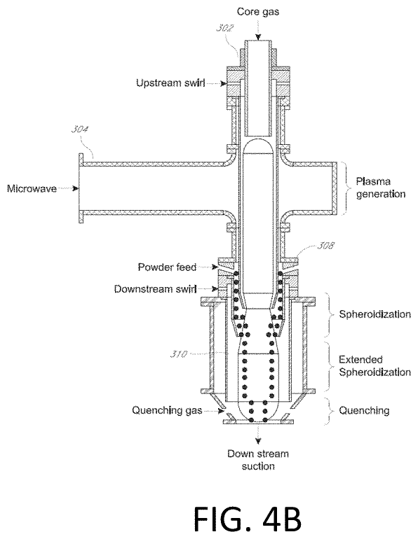

FIGS. 4A-4B illustrate an exemplary microwave plasma torch that includes a side feeding hopper rather than the top feeding hopper shown in the embodiment of FIG. 5, thus allowing for downstream feeding. Thus, in this implementation the feedstock is injected after the microwave plasma torch applicator for processing in the “plume” or “exhaust” of the microwave plasma torch. Thus, the plasma of the microwave plasma torch is engaged at the exit end of the plasma torch to allow downstream feeding of the feedstock, as opposed to the top-feeding (or upstream feeding) discussed with respect to FIG. 5. This downstream feeding can advantageously extend the lifetime of the torch as the hot zone is preserved indefinitely from any material deposits on the walls of the hot zone liner. Furthermore, it allows engaging the plasma plume downstream at temperature suitable for optimal melting of powders through precise targeting of temperature level and residence time. For example, there is the ability to dial the length of the plume using microwave powder, gas flows, and pressure in the quenching vessel that contains the plasma plume.

Generally, the downstream spheroidization method can utilize two main hardware configurations to establish a stable plasma plume which are: annular torch, such as described in U.S. Pat. Pub. No. 2018/0297122, or swirl torches described in U.S. Pat. Nos. 8,748,785 B2 and 9,932,673 B2. Both FIG. 4A and FIG. 4B show embodiments of a method that can be implemented with either an annular torch or a swirl torch. A feed system close-coupled with the plasma plume at the exit of the plasma torch is used to feed powder axisymmetrically to preserve process homogeneity.

Other feeding configurations may include one or several individual feeding nozzles surrounding the plasma plume. The feedstock powder can enter the plasma at a point from any direction and can be fed in from any direction, 360° around the plasma, into the point within the plasma. The feedstock powder can enter the plasma at a specific position along the length of the plasma plume where a specific temperature has been measured and a residence time estimated for sufficient melting of the particles. The melted particles exit the plasma into a sealed chamber where they are quenched then collected.

The feed materials 314 can be introduced into a microwave plasma torch 302. A hopper 306 can be used to store the feed material 314 before feeding the feed material 314 into the microwave plasma torch 302, plume, or exhaust. The feed material 314 can be injected at any angle to the longitudinal direction of the plasma torch 302. 5, 10, 15, 20, 25, 30, 35, 40, 45, 50, or 55 degrees. In some embodiments, the feedstock can be injected an angle of greater than 5, 10, 15, 20, 25, 30, 35, 40, 45, 50, or 55 degrees. In some embodiments, the feedstock can be injected an angle of less than 5, 10, 15, 20, 25, 30, 35, 40, 45, 50, or 55 degrees. In alternative embodiments, the feedstock can be injected along the longitudinal axis of the plasma torch.

The microwave radiation can be brought into the plasma torch through a waveguide 304. The feed material 314 is fed into a plasma chamber 310 and is placed into contact with the plasma generated by the plasma torch 302. When in contact with the plasma, plasma plume, or plasma exhaust, the feed material melts. While still in the plasma chamber 310, the feed material 314 cools and solidifies before being collected into a container 312. Alternatively, the feed material 314 can exit the plasma chamber 310 while still in a melted phase and cool and solidify outside the plasma chamber. In some embodiments, a quenching chamber may be used, which may or may not use positive pressure. While described separately from FIG. 5, the embodiments of FIGS. 4A-4B are understood to use similar features and conditions to the embodiment of FIG. 5.

In some embodiments, implementation of the downstream injection method may use a downstream swirl, extended spheroidization, or quenching. A downstream swirl refers to an additional swirl component that can be introduced downstream from the plasma torch to keep the powder from the walls of the tube. An extended spheroidization refers to an extended plasma chamber to give the powder longer residence time. In some implementations, it may not use a downstream swirl, extended spheroidization, or quenching. In some embodiments, it may use one of a downstream swirl, extended spheroidization, or quenching. In some embodiments, it may use two of a downstream swirl, extended spheroidization, or quenching.

Injection of powder from below may result in the reduction or elimination of plasma-tube coating in the microwave region. When the coating becomes too substantial, the microwave energy is shielded from entering the plasma hot zone and the plasma coupling is reduced. At times, the plasma may even extinguish and become unstable. Decrease of plasma intensity means decreases in spheroidization level of the powder. Thus, by feeding feedstock below the microwave region and engaging the plasma plume at the exit of the plasma torch, coating in this region is eliminated and the microwave powder to plasma coupling remains constant through the process allowing adequate spheroidization.

Thus, advantageously the downstream approach may allow for the method to run for long durations as the coating issue is reduced. Further, the downstream approach allows for the ability to inject more powder as there is no need to minimize coating.

From the foregoing description, it will be appreciated that inventive processing methods for the formation of silicon products are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A method for producing a spheroidized powder from a silica source, the method comprising:
introducing silica source feed material into a microwave plasma torch; and
melting and spheroidizing the silica source feed material within a plasma generated by the microwave plasma torch to form a spheroidized powder.

2. The method of claim 1, further comprising forming an anode from the spheroidized powder.

3. The method of claim 2, further comprising forming a battery from the anode.

4. The method of claim 1, wherein high energy milling is not used.

5. The method of claim 1, wherein lithographic processing is not used.

6. The method of claim 1, wherein the silicon spheroidized powder is Si or SiOₓ.

7. The method of claim 1, wherein the silica source feed material is a diatom.

8. The method of claim 1, wherein the silica source feed material is a silica colloid.

9. The method of claim 1, wherein the silica source feed material is fumed silica.

10. The method of claim 1, wherein the microwave plasma torch uses a gas selected from the group consisting of hydrogen, oxygen, argon, carbon monoxide and methane.

11. The method of claim 10, wherein the gas is under high pressure.

12. A method for reducing silica materials using a plasma, the method comprising
introducing silica source feed material into a microwave plasma torch;
introducing a reducing gas into the microwave plasma torch; and
melting and spheroidizing the silica source feed material within a plasma generated by the microwave plasma torch to form a spheroidized powder.

13. The method of claim 12, wherein the spheroidized powder is Si or SiOₓ.

14. A method for reducing silica materials using a plasma, the method comprising
introducing silica source feed material into a microwave plasma torch, the silica source contacted with one or more solid reducing agents;
introducing a reducing gas into the microwave plasma torch; and
melting and spheroidizing the silica source feed material within a plasma generated by the microwave plasma torch to form a spheroidized powder.

15. The method of claim 14, wherein the plasma is generated by a microwave source via a torch.

16. The method of claim 14, wherein the silica materials compounded with the one or more solid reducing agents.

17. The method of claim 16, wherein the one or more solid reducing agents comprise carbon.

18. The method of claim 16, wherein the one or more solid reducing agents comprise metal.

19. The method of claim 14, wherein a metal catalyst is added to silica source feed material prior to introducing the silica source feed material into the microwave plasma source.

20. The method of claim 14, wherein a salt composition formulated to melt in the plasma is added to the microwave plasma torch.
